(19) United States
(12) Patent Application Publication
(10) Pub. No.: US 2014/0141130 A1
(43) Pub. Date: May 22, 2014

(54) Daily all foods

(71) Applicant: Scott Joseph, Pembroke Pines, FL (US)

(72) Inventor: Scott Joseph, Pembroke Pines, FL (US)

(73) Assignees: Carmen Saavedra, Hollywood, FL (US); Scott Joseph, Pembroke Pines, FL (US)

(21) Appl. No.: 13/987,639

(22) Filed: Aug. 19, 2013

Related U.S. Application Data
(63) Continuation-in-part of application No. 13/694,307, filed on Nov. 19, 2012.

(51) Int. Cl. A23L 1/29

(52) U.S. Cl. CPC A23L 1/296
USPC 426/93; 426/531; 426/615; 426/618; 426/632; 426/629; 426/634; 426/89; 53/396

(57) ABSTRACT

The composition and process of a set of food products whereas each individual food product is composed from ingredients within a specific food group, which are measured and processed to a full day's supply according to USDA Dietary Guidelines, sold individually or in a box of seven for the week.

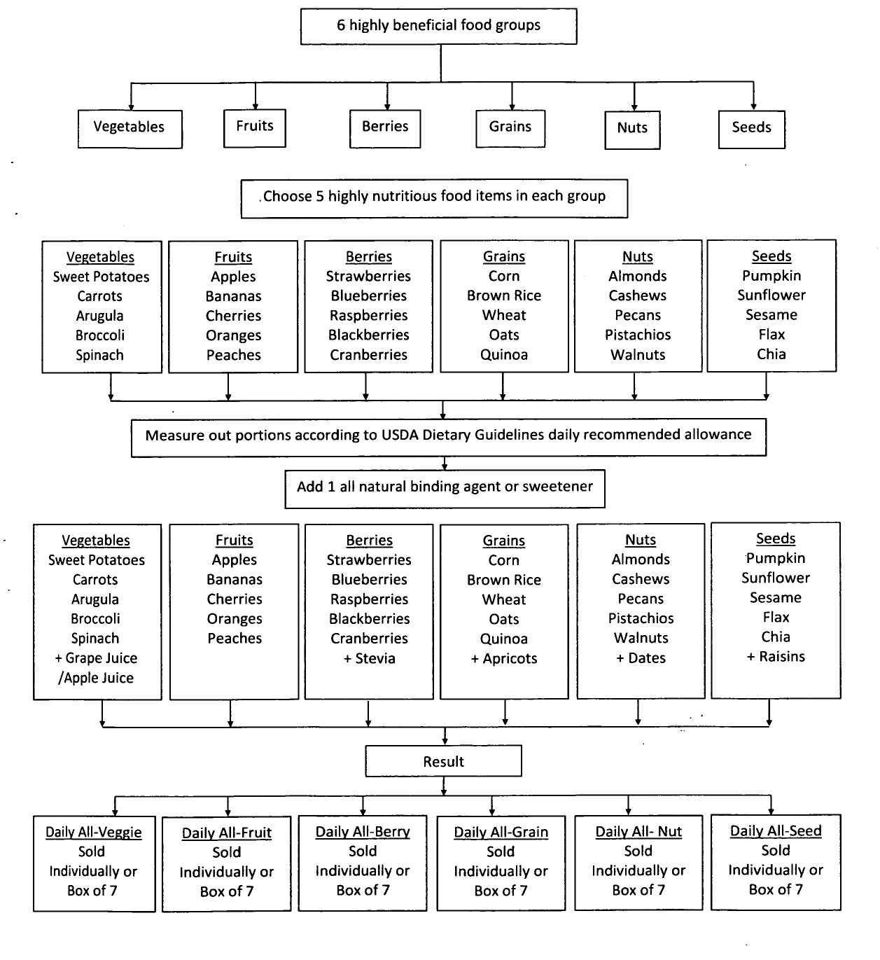

### BACKGROUND OF THE INVENTION

In hopes of living a disease free and long life through a diet containing well proportioned, naturally whole foods with high nutritional value, avoiding all meats, dairy and excessively processed foods, allowing for the creation of making these otherwise fair tasting plant-based foods to taste good and to be conveniently packaged.

### BRIEF SUMMARY OF THE INVENTION

It is the object of the invention to provide a highly nutritious food serving comprised of all natural foods within a specific group, portioned to the recommended amount, minimally processed, then sold individually or in a box of 7.

Highly nutritional food groups are selected such as but not limited to Vegetables, Fruits, Berries, Grains, Nuts, Seeds, and Pulses. From each group, food items are selected because of their high nutritional values which are then measured out to create a full day's portion according to the USDA Dietary Guidelines. Then they are combined with one other all natural binding agent, sweetener, or spice such as but not limited to Apples, Grapes, Dates, Raisins, Cranberries, Apricots, Figs, Stevia, and Cumin to create 1 serving. There are no other added ingredients. The servings are packaged individually or in a box of 7 for the week for each food group, 1 serving for each day of the week. This will create a unique dietary plan that will allow the individual to consume 1 full day's supply of each food group that they can eat or snack-on which will allow them to reach their USDA Dietary Guidelines recommended daily allowance of nutrients.

### DETAILED DESCRIPTION OF THE INVENTION

Process for creating the servings are as follows:

1. Vegetable Food Drink: Composed of equal amounts of vegetables such as but not limited to: Sweet Potatoes, Carrots, Arugula, Broccoli, and Spinach and portioned out to its recommended daily allowance according to USDA Dietary Guidelines. Blended together with one all natural sweetener such as but not limited to Grape Juice or Apple Juice, to form 1 food drink.

2. Fruit Food Drink: Composed of equal amounts of fruits such as but not limited to: Apples, Bananas, Cherries, Oranges and Peaches, and portioned out to its recommended daily allowance according to USDA Dietary Guidelines. Blended together to form 1 food drink. 3. Berry Food Drink: Composed of equal amounts of berries such as but not limited to: Strawberries, Blueberries, Raspberries, Blackberries, and Cranberries and portioned out to its recommended daily allowance according to USDA Dietary Guidelines. Blended together with one all natural sweetener such as but not limited to Stevia to form 1 food drink. 4. Super Blend Food Drink: Composed of equal amounts of vegetables, fruit, berries, nuts, and seeds and portioned out to ¼ of its recommended daily allowance according to USDA Dietary Guidelines. Blended together with one all natural sweetener such as but not limited to Orange, Apple, Pineapple, or Grape Juice, to form 1 food drink. Can also add Stevia. 5. Grain Bar: Composed of equal amounts of grains such as but not limited to: Corn, Rice, Wheat, Oats, and Quinoa and portioned out to its recommended daily allowance according to USDA Dietary Guidelines. Mixed together with one all natural binding agent such as but not limited to Raisins, Dates, or Figs to form 1 bar. 6. Nut Bar: Composed of equal amounts of nuts such as but not limited to: Almonds, Cashews, Pecans, Pistachios, and Walnuts and portioned out to its recommended daily allowance according to USDA Dietary Guidelines. Mix with one all natural binding agent such as but not limited to Raisins, Dates, or Figs to form 1 bar. 7. Seed Bar: Composed of equal amounts of seeds such as but not limited to: Pumpkin, Sunflower, Sesame, Flax, and Chia seeds and portioned out to its recommended daily allowance according to USDA Dietary Guidelines. Mix the seeds and one all natural binding agent such as but not limited to Raisins, Dates, or Figs to form 1 bar.

8. Pulse Spread: Composed of equal amounts of pulses such as but not limited to: Black Beans, Chickpeas, Garden Peas, Green Lentils, and Kidney Beans and portioned out to its recommended daily allowance of 8 oz total serving. Blend the pulses together with one spice such as but not limited to Cumin to form 1 serving.

9. Fruit packs: Composed of equal amounts of dried and/or fresh fruits or one in particular such as but not limited to Apples, Bananas, Cherries, Oranges and Peaches, and portioned out to its recommended daily allowance according to USDA Dietary Guidelines.

10. Berry packs: Composed of equal amounts of dried or fresh berries or one in particular such as but not limited to: Strawberries, Blueberries, Raspberries, Blackberries, and Cranberries and portioned out to its recommended daily allowance according to USDA Dietary Guidelines.

11. Vegetable packs: Composed of equal amounts of dried or fresh vegetables or one in particular such as but not limited to: Sweet Potatoes, Carrots, Arugula, Broccoli, and Spinach and portioned out to its recommended daily allowance according to USDA Dietary Guidelines.

12. Nut packs: Composed of equal amounts of nuts or one in particular such as but not limited to: Almonds, Cashews, Pecans, Pistachios, and Walnuts and portioned out to its recommended daily allowance according to USDA Dietary Guidelines.

13. Seed packs: Composed of equal amounts of seeds or one in particular such as but not limited to: Pumpkin, Sunflower, Sesame, Flax, and Chia seeds and portioned out to its recommended daily allowance according to USDA Dietary Guidelines.

14. Products can be sold individually or in sets of 7 (one per day, per week)

### BRIEF DESCRIPTION OF THE DRAWING

The FIGURE is a flow chart of one embodiment of the process for manufacturing a nutritionally complete food bar in accordance with the invention

We claim:

1. A set of food products whereas each individual food product is composed from ingredients within a specific food group, which are measured and processed to a full day's supply according to USDA Dietary Guidelines.

2. The invention of claim 1 comprising of 5 equal parts of vegetables, which are measured and processed to a full day's supply according to USDA Dietary Guidelines, plus a natural sweetener.

3. The invention of claim 1 comprising of 5 equal parts of fruits, which are measured and processed to a full day's supply according to USDA Dietary Guidelines.

4. The invention of claim 1 comprising of 5 equal parts of berries, which are measured and processed to a full day's supply according to USDA Dietary Guidelines, plus a natural sweetener.

5. The invention of claim 1 comprising of 5 equal parts of grains, which are measured and processed to a full day's supply according to USDA Dietary Guidelines, plus a natural biding agent.

6. The invention of claim 1 comprising of 5 equal parts of nuts, which are measured and processed to a full day's supply according to USDA Dietary Guidelines, plus a natural binding agent.

7. The invention of claim 1 comprising of 5 equal parts of seeds, which are measured and processed to a full day's supply according to USDA Dietary Guidelines, plus a natural binding agent.

8. The invention of claim 1 comprising of equal parts of vegetables, fruits, and berries, which are measured and processed to ⅓ of a full day's supply according to USDA Dietary Guidelines, plus a natural sweetener.

9. The invention of claim 1 comprising of equal parts of pulses, which are measured and processed to a full day's supply plus one spice.

10. The food of claim 2, said sweetening ingredient being selected from the following ingredients such as but not limited to Grape Juice, Apple Juice, Orange Juice, Pineapple Juice, and Stevia.

11. The food of claim 4, said sweetening ingredient being selected from the following ingredients such as but not limited to Grape Juice, Apple Juice, Orange Juice, Pineapple Juice, and Stevia.

12. The food of claim 5, said binding agent being selected from the following ingredients such as but not limited to Dates, Raisins, Figs, and Apricots.

13. The food of claim 6, said binding agent being selected from the following ingredients such as but not limited to Dates, Raisins, Figs, and Apricots.

14. The food of claim 7, said binding agent being selected from the following ingredients such as but not limited to Dates, Raisins, Figs, and Apricots.

15. The food of claim 8, said sweetening ingredient being selected from the following ingredients such as but not limited to Grape Juice, Apple Juice, and Stevia.

16. The food of claim 9 said spice being selected from the following ingredients such as but not limited to Cumin and Chili Powder.

17. Packaging said items 7 per box, which allows consumer a daily consumption for 1 week, which can also replace daily meals.
